(19) United States
(12) Patent Application Publication
(10) Pub. No.: US 2007/0160451 A1
(43) Pub. Date: Jul. 12, 2007

(54) Small load lifting mechanism

(76) Inventor: Angelo Gencarelli, Eden Park (AU)

Correspondence Address: LAW OFFICE OF JOHN W. HARBST, 1180 LITCHFIELD LANE, BARTLETT, IL, 60103, US

(21) Appl. No.: 11/702,693

(22) Filed: Feb. 6, 2007

Related U.S. Application Data
(63) Continuation-in-part of application No. PCT/AU05/01182, filed on Aug. 8, 2005.

(30) Foreign Application Priority Data
Aug. 6, 2004 (AU) 2004904424

(51) Int. Cl. B65F 3/00; B62B 3/06

(52) U.S. Cl. 414/546; 254/2 R

(57) ABSTRACT

A load lifting mechanism including a telescoping mechanism, a pump lever operable to extend the telescoping mechanism, and a drive apparatus operably coupled to the pump lever, and wherein the drive mechanism is operable to actuate the pump lever so the telescoping mechanism is extended to lift a load.

### CROSS REFERENCE TO RELATED APPLICATION

This is a Continuation-In-Part application of International Application Number PCT/AU2005/001182 having an International Filing Date of 08 Aug. 2005 Aug.8, 2005and which claims priority of Australian patent application Serial No. 2004904424 filed on 06 Aug. 2004 Jun.8, 2004.

### FIELD OF THE INVENTION

This invention relates to improved lifting mechanisms for vehicular applications and particularly to lifting mechanisms for use where forces in such ranges as 500 kg, 1000 kg or 1500 kg are to be developed.

### BACKGROUND

The alternatives presented for those in the market for small load capacity lifting mechanisms for application to vehicles are limited. Large load capacity lifting mechanisms utilizing hydraulic or pneumatic rams have been described for applications such as tray lifting mechanisms for tip trucks, heavy load lifting cranes, systems for lifting refuse bins onto trucks have been described, amongst many others. However, their adaptation to light or low load lifting vehicular applications may involve over-engineering and excessive costs.

For example, where hydraulics are considered for use in a lifting mechanism, the cost, weight and complexity of providing and controlling a flow of hydraulic oil under pressure to the actual force-generating devices such as hydraulic cylinders can be prohibitive in small sizes. Maintenance costs can also be excessive.

In some applications where comparatively small loads are to be lifted, winch-based mechanisms optionally powered by an electric motor or by a vehicle's electrical system have been proposed. However, winch mechanisms are poorly adapted to many applications such as, for example, tray-tiliting mechanisms.

Accordingly, there is a need for alternative small load lifting mechanisms for vehicular applications such as the provision of tilting-tray facilities on small vehicles and towed trailers, and it is an object of the present invention to provide such mechanisms.

The above description of the prior art is not intended to be, nor should it be interpreted as, a statement or admission as to the common general knowledge in the art in Australia.

### SUMMARY OF THE INVENTION

The invention provides a load lifter for use in vehicular applications comprising.

a ram having a telescoping means and a pump lever operable to extend said telescoping means;

drive means operably coupled to the pump lever, and means for mounting the ram to a structural part of a vehicle, wherein the drive means is operable to actuate the pump lever so that the telescoping means is extended to lift a load.

Preferably, the load lifter has a load lifting capability less than or equal to about 1.5 tonnes, particularly less than or equal to about 1 tonne, and more particularly less than or equal to about 500 kg.

In the preferred embodiment of the invention, the ram is one of a hydraulic ram and a pneumatic ram, the ram comprises a cylinder and the telescoping means comprises a piston movable within the cylinder.

The ram may be of the telescopic type. That is, the telescoping means may comprise a plurality of pistons concentric with one another so as to be extendable telescopically.

The pump lever is preferably rotatable about a pivot point associated with the cylinder and operatively coupled to a pump.

It is particularly preferred that a pump is associated with the cylinder and operable by the pump lever to pump a fluid into the cylinder whereby to extend the telescoping means.

The load lifter may further comprise control means having positions selectable by a user to cause actuation of the pump lever to either extend or retract the telescoping means.

The load lifter may comprise control means operable to permit bleeding of the fluid from the cylinder so that a load acting on the telescoping means retracts the telescoping means.

The drive means may comprise one of an internal combustion engine and an electric motor. However, it is especially preferred that the drive means comprises an electric motor and further comprises means for powering the electric motor from an electrical system of the vehicle.

In one embodiment, the pump lever is movable by a linearly reciprocating component of the drive means connected by one or more linkages to the pump lever.

Preferably however, the drive means in use causes rotation of a crank and a link connects the crank to the pump lever whereby to impart a reciprocating movement to the pump lever.

Preferably the ram is secured to a support component that is pivotally mountable either to the said structural part of the vehicle or to a base part mounted to the said structural part of the vehicle.

Advantageously, the drive means is secured to at least one of the said support component and the ram so as to be in a fixed position relative to the ram. This simplifies the connection of the drive means to the pump lever.

In one embodiment, the load to be lifted may be or include a movable part of the vehicle, the load lifter being secured to the vehicle structural part and operable to raise and lower the movable part. The movable part of the vehicle may be a load tray pivotally mounted to the vehicle, the load lifter being operable to raise the tray to a tilted position from a lowered position.

Preferably in this embodiment the load lifter has an intermediate movable element mounted to the vehicle and able to be moved between first and second positions by the ram, the said element being connected to the said movable part of the vehicle by at least one connecting link.

This movable element may comprise an elongate boom with the telescoping means being pivotally secured to the boom at a point partway along the length of the boom.

In some applications, it has been found advantageous for the boom to be of curved shape and concave downward.

It is particularly preferred that the load lifter be based on use of a hydraulic jack. Thus, in a further aspect, the invention provides a load lifter comprising:
a hydraulic jack having a piston slidable in a cylinder, a pump for pumping oil into the cylinder below the piston whereby to raise the piston and a pump lever adapted for operation of the pump;
drive means operably coupled to the pump lever; and
means for mounting the jack to a structural part of a vehicle,
wherein the drive means is operable to actuate the pump lever so that the piston or a piston rod secured thereto is extended to lift a load thereon.

Preferably in this aspect, the drive means is adapted to rotate a crank arm that is connected by a link to the pump lever, so that rotation of the crank arm reciprocates the pump lever of the jack.

In another aspect, the present invention is a tipping unit for a vehicle comprising:
a base mountable to a body of the vehicle;
one or more connector members attachable to a tipping platform of the vehicle;
a boom arm pivotally connected at a first end to the base and pivotally connected at a second end to the one or more connector members;
a hydraulic jack pivotally mounted to said base and having a piston slidable in a cylinder and a pump for raising said piston, the piston being connectable at a distal end to the boom arm; and
a drive unit mounted to said base and operably coupled to a lever of the pump to drive the pump,
wherein raising of the piston causes the boom arm to move between a first position wherein said tipping platform is substantially horizontal for carrying a load and a second position wherein said tipping platform is angled to the horizontal.

In yet another aspect, the present invention is a tipping assembly for a vehicle comprising:
a base frame mountable to a body of the vehicle;
a support frame hingedly attached to the base frame at one end and configured to receive a tipping platform of a vehicle; and
a tipping unit mounted to said base frame and said support frame, said tipping unit having;
   a boom arm pivotally connected at a first end to the base frame and pivotally connected at a second end to the support frame;
   a hydraulic jack pivotally mounted to said base frame and having a piston slidable in a cylinder and a pump for raising said piston, the piston being connectable at a distal end to the boom arm; and
   a drive unit mounted to said base frame and operably coupled to
a lever of the pump to drive the pump,
wherein raising of the piston causes the boom arm to move between a first position wherein said support frame is substantially horizontal and a second position wherein said support frame is angled to the horizontal.

In order that the invention may be better understood, and further inventive features disclosed, there will now be described, a preferred embodiment as shown in the attached Figures, of which:

FIG. 1 is an elevation of a hydraulic ram and a drive unit;

FIG. 2 is a schematic side view, omitting some mechanical details) of a trailer provided with a tipping tray using the invention;

FIG. 3 is a perspective view of a part of the trailer shown in FIG. 2;

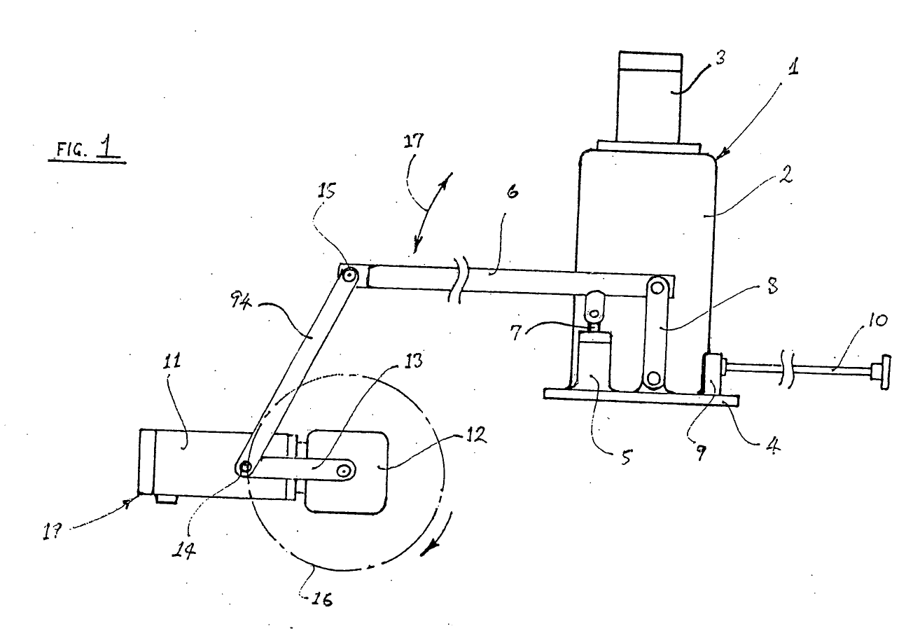

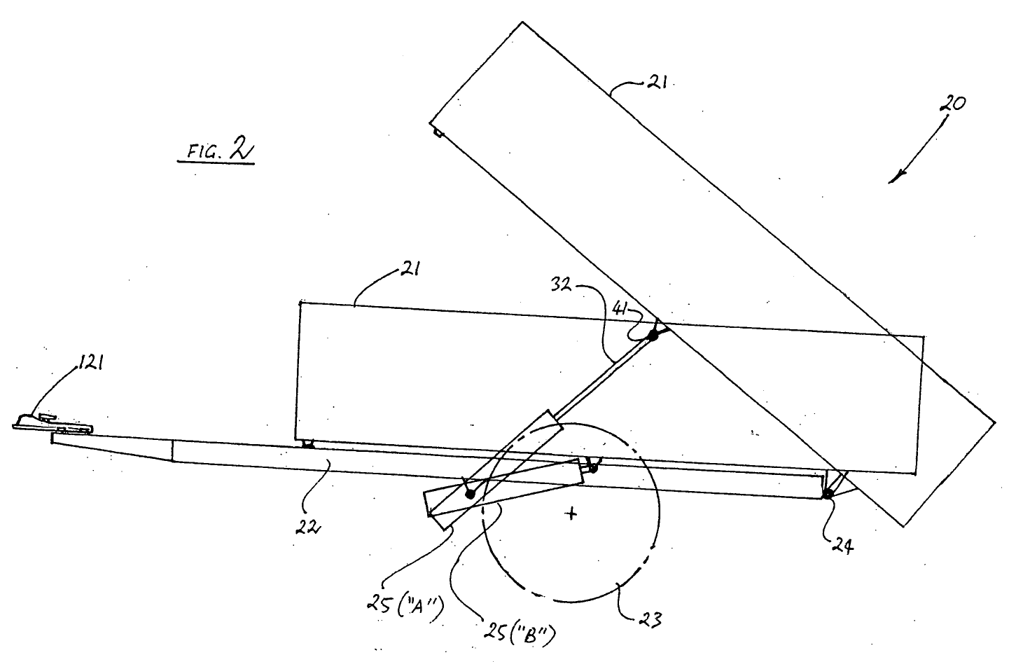

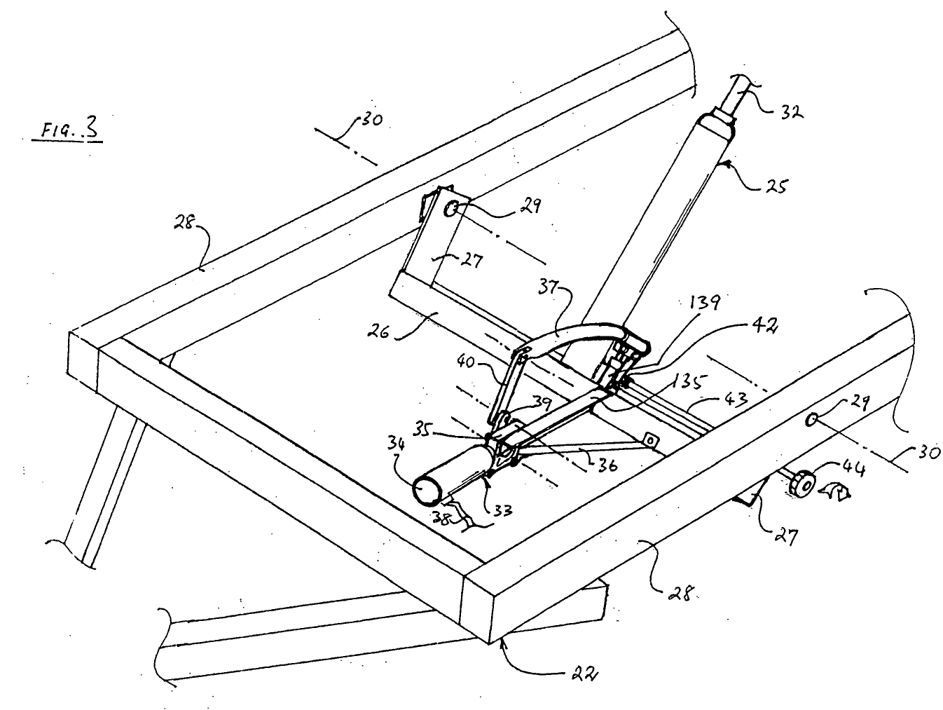

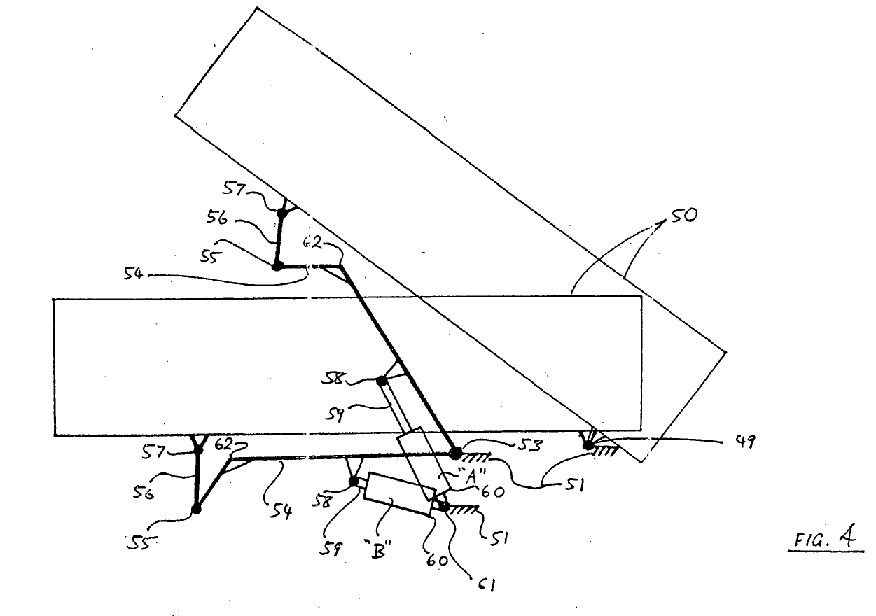

FIG. 4 is a schematic side view, omitting some mechanical details, of a tipping tray of a trailer or vehicle and its actuating mechanism, according to the invention;

FIG. 5 is a perspective view of a portion of the actuating mechanism as shown in FIG. 4;

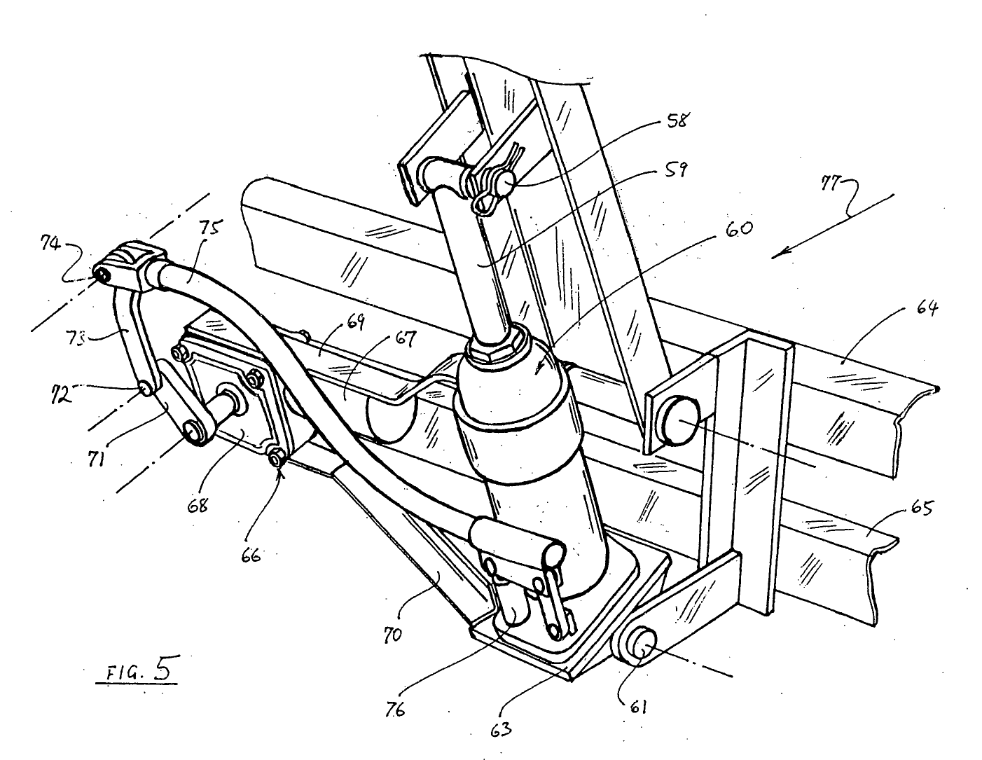

FIG. 6 is a pair (marked a and b) of elevations of a hydraulic ram and an actuating mechanism therefore, according to a further embodiment of the invention;

FIG. 7 is a side elevation of a further lifting apparatus according to the invention;

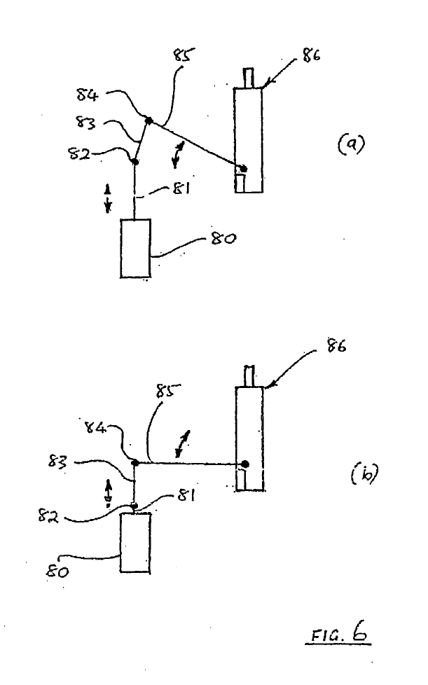

FIG. 8 is an elevation of the apparatus shown in FIG. 7, as seen looking in the direction of arrow “Q”;

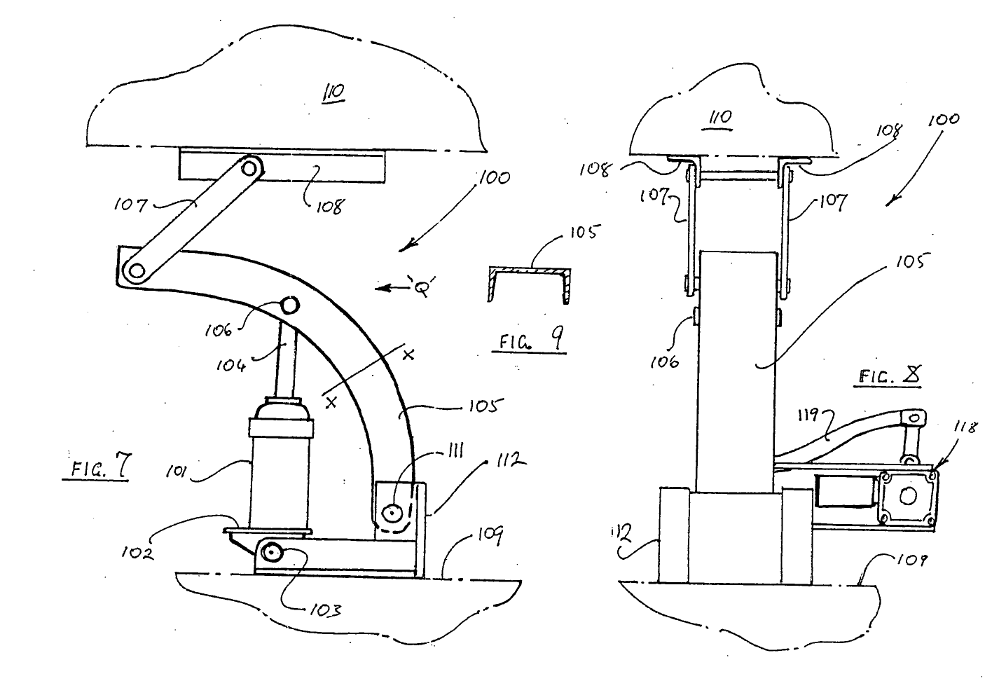

FIG. 9 is a cross sectional view of a component of the apparatus shown in FIG. 7, the section being taken at station “XX”;

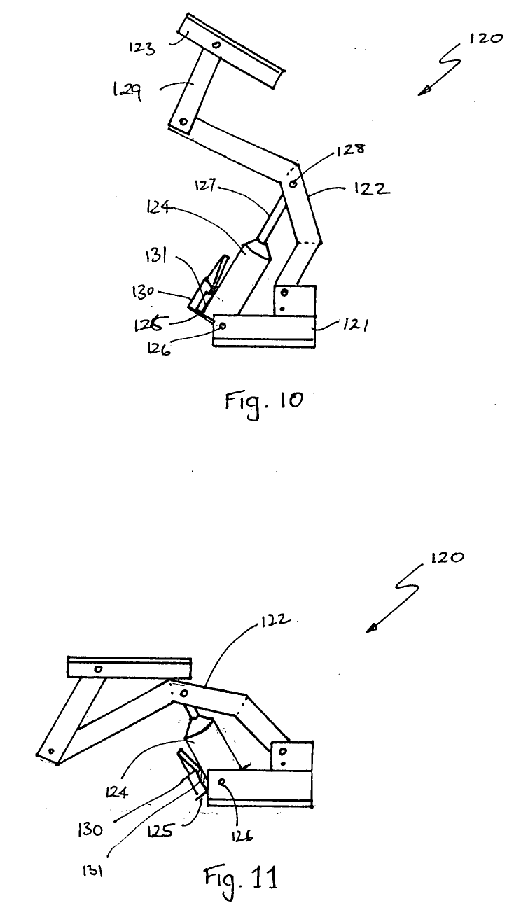

FIG. 10 is a side elevation of a tipping unit according to one embodiment of the present invention;

FIG. 11 is a side elevation of the tipping unit shown in FIG. 10 with the tipping unit in a retracted position;

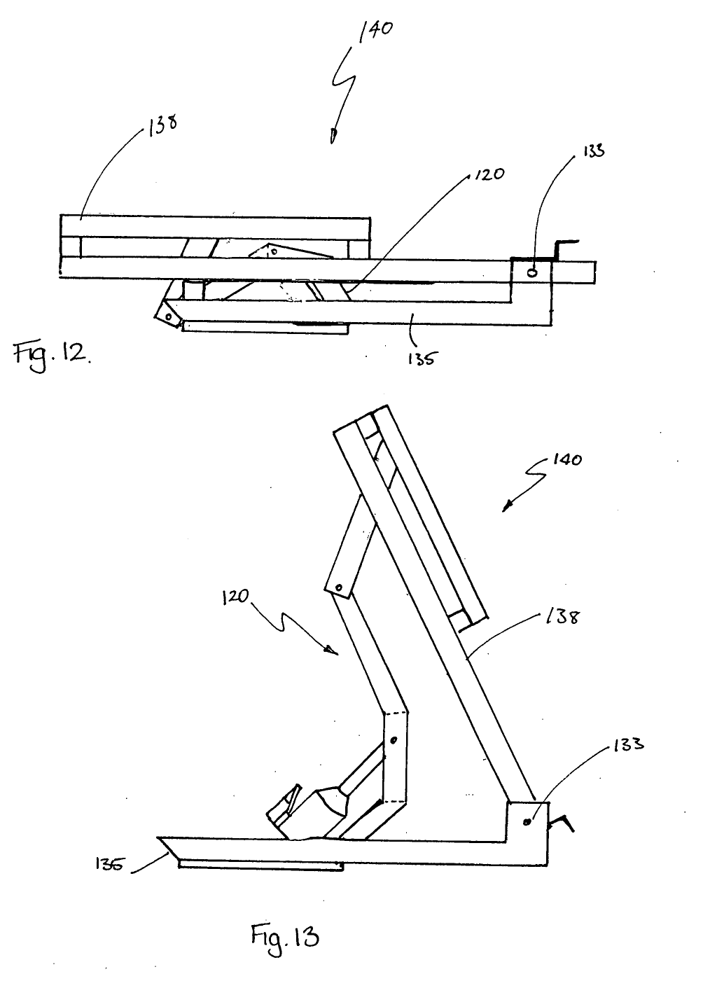

FIG. 12 is a side elevation of a tipping assembly according to another embodiment of the present invention; and

FIG. 13 is a side elevation of the tipping assembly shown in FIG. 12 in an extended position.

### DETAILED DESCRIPTION OF PREFERRED EMBODIMENTS

FIG. 1 shows a hydraulic ram 1 and a drive unit 19 that actuates ram 1 according to the invention. Ram 1 is of a type widely used as a jack and suitable for use in practice of the present invention. Ram 1 has a cylinder and piston (not shown) in a casing 2 and a telescoping piston rod 3 secured to the piston, and which can raise a load as oil is pumped into the cylinder below the piston. Casing 2 is secured to a base plate 4. A reciprocating piston-type pump 5 is mounted to casing 2 and can pump oil into the cylinder from an oil chamber (not shown) within the casing 2. Pump 5 is operable by a pump lever 6 that is pivotally secured to a plunger 7 of pump 5 and to a link 8. Link 8 in turn is pivotally mounted to the base plate 4. A valve 9 is provided for bleeding oil from the cylinder back into the oil chamber so as to allow retraction of the jack. Valve 9 is operable by rotation of a control rod 10.

Some jack-type rams provide, instead of or additionally to such a valve, means whereby oil can optionally be pumped into a space (not shown) above the piston so that retraction can be achieved by this means instead of or in addition to applying a force to the piston rod. Still other rams provide multiple concentric pistons that telescope within one another to achieve a greater ratio of lift stroke to cylinder length than is possible with a single piston. These rams too are usable with the invention.

Jacks that combine a cylinder and telescoping piston with an oil (or other working fluid) reservoir, a lever-actuated pump and suitable control valve(s) are especially convenient for practice of the present invention. However, it is not intended to imply that such jacks are the only form of rams that may be used in practice of the invention.

An advantage of rams such as ram 1 is that they require no connection to an external hydraulic oil supply. This can greatly simplify the provision of lifting device that is compact and powered by means other than manual means.

Drive unit 19 comprises an electric motor 11 coupled to a speed reducer 12. Speed reducer 12 is preferably a gear type speed reducer, whose output shaft rotates a crank arm 13. Crank arm 13 is pivotally connected to one end 14 of a link rod 94 whose other end 15 is pivotally connected to pump lever 6. The result is that when motor 11 is driven from a suitable electric power supply (not shown), point 14 describes a circular path 16 and lever 6 is pumped up and down as shown by arrow 17, thus actuating ram 1 to lift a load applied downwardly to the piston rod 3.

FIGS. 2 and 3 show the application of the invention to a vehicle-towable road trailer 20 provided with a load tray 21 that can tilt to dump its load. Referring to FIG. 2, from which unnecessary mechanical detail has been omitted, there is shown a trailer 20, suitable for towing by an automobile or the like with a hitch connection 121. Trailer 20 includes a frame 22 mounted on wheels 23. Tip tray 21 is hingedly connected to the frame 22 by a 10 pair of hinges 24 at the rear of the frame 22.

A ram 25 is provided for raising and lowering tray 21 and is shown in two positions in FIG. 2, position “A” corresponding to the raised position of tray 21 and position “B” corresponding to the lowered position of tray 21. Piston rod 32 of ram 25 is connected to tray 21 at pivot 41.

Referring now to FIG. 3, ram 25 is mounted to a bar 26 that extends between a pair of spaced generally upright members 27. Members 27 are hingedly mounted to side girders 28 of frame 22 at hinged connections 29 so that the bar 26 is free to pivot about an axis 30 through hinged connections 29. Thus, ram 25 can pivot about axis 30. This arrangement allows ram 25 to change its angle relative to frame 22 and tray 21 as tray 21 is raised and lowered. The arrangement further allows suitable positioning of axis 30 along the length of ram 25 so as to provide advantageous geometry throughout the stroke of ram 25 and to avoid possible buckling of ram 25 at full extension of its piston rod 32.

Also mounted to the pivot bar 26, is a drive unit 33 comprising an electric motor 34 and geared speed reducer 35. Drive unit 33 is mounted to the pivot bar 26 by a main bracket 135 and a stabilizing cross strut 36 in combination adapted to fix the drive unit relative to the pivot bar 26 and therefore to ram 25. The combination of drive unit 33 and ram 25 is similar to the arrangement shown in FIG. 1, and operates in the same way. By securing drive unit 33 and ram 25 to bar 26, the relative positions of drive unit 33 and ram 25 are preserved at all operating positions of ram 25.

Pump lever 37 of ram 25 is shown as curved and this assists in provision of a compact arrangement for driving ram 25 with drive unit 33. However a straight pump lever could be used instead.

The motor 34 is powered, via an electrical cable 38, from the electrical system of the towing vehicle (not shown) or any other suitable electrical supply. A suitable electrical switch (not shown) is provided, preferably on trailer 20 itself, to switch motor 34 on and off.

To raise tray 21, the motor 34 is switched on and rotates the crank 39 whereby a link 40 reciprocatingly actuates the pump lever 37 and in turn operates the pump 139 of ram 25 to extend piston rod 32.

The pivot 41 may be located towards the front of the underside of the tip tray 21 to lessen the load on the ram 25 or may be placed at a position intermediate the length of the tip tray 21 to allow use of a shorter ram 25.

To lower tray 21, a user operates a release valve 42 that is connected by an extension 43 to a knob 44 which is mounted to the bar 26 and below frame 22 out of the way of the descending tip tray 21. The user may control the descent of the tip tray 21 whereby to permit it to gently return to its lowermost position where it can be secured to the frame 22 optionally by a latch or clamp device (not shown).

Other positions of controls for release valve 42 may be chosen, but may require an articulated extension (unlike rigid extension 43) to accommodate the changing orientation of the ram 25 relative to the frame 22. A flexible cable may also be provided as an alternative to operate release valve 42, for example a so-called “Bowden” cable having a flexible cable in a flexible supporting sheath.

The drive unit 33 may be enclosed in a cover (not shown) both for aesthetic and practical purposes, that is to keep the mechanism free of dust, mud and grime to which the trailer 20 may be exposed in use.

Another way to provide a tilting tray facility for a trailer or vehicle using the invention will now be described. FIG. 4 is a schematic side view (i.e. with unimportant mechanical detail omitted) of a tray 50 that is pivotally mounted by hinges 49 to a fixed frame (represented by a symbol 51 in FIG. 4) that may be a trailer frame (like frame 22) or a chassis of a road vehicle (not shown) such as a small utility vehicle. Tray 50 is shown in raised and lowered positions in FIG. 4.

Also hingedly connected to the frame at a pivot 53 is a beam 54. Beam 54 is pivotally connected to one end 55 of a link 56 and the other end 57 of link 56 is connected pivotally to tray 50. Pivotally connected to beam 54 is upper end 58 of a piston rod 59 of a ram 60. Ram 60 is itself connected to the frame at a pivot 61 in a way described below. Position “A” of ram 60 in FIG. 4 corresponds to the raised position of tray 50 and position “B” corresponds to the lowered position of tray 50.

Beam 54 is shown in FIG. 4 as having a bend 62, but persons skilled in the art will recognize that this is not essential. Beam 54 happens to provide a compact arrangement, which is important in tray raising applications.

Comparison of FIGS. 2 and 4 shows that a shorter ram can be used in the arrangement of FIG. 4. The arrangement shown in FIG. 4 can also be proportioned to provide a better match between the available thrust on piston rod 59 and the effort required to raise the tray 50 from its lowered position to its raised position.

FIG. 5 shows the mechanical arrangement for mounting and actuation of ram 60. Only a part of the frame is shown, namely transverse beams 64 and 65. Ram 60 is mounted on a platform 63 that is in turn pivotable about pivot 61, so that the combination of ram 60 and platform 63 pivots together about pivot 61.

A drive unit 66, comprising an electric motor 67 and gear-type speed reducer 68 is secured by brackets 69 and 70 so as be in a fixed position relative to ram 60 irrespective of the position of ram 60. Brackets 69 and 70 are secured to the ram 60 and the platform 63 respectively.

Drive unit 66 when operated from a suitable electric supply rotates a crank arm 71 that is pivotally connected to one end 72 of a link 73. The other end 74 of link 73 is pivotally connected to pump lever 75 of ram .60. Lever 75 actuates a plunger-type pump 76 that is integral with ram 60.

Drive unit 66 is mounted substantially beside ram 60 (i.e. so that lever 75 extends approximately transversely to the direction of travel 77 of the vehicle) for compactness and approximately constant ground clearance. (In contrast, in the arrangement in FIGS. 2 and 3, drive unit 33 will have a ground clearance that varies as bar 26 swings during raising and lowering of tray 21.)

Although not shown in FIG. 5, a suitable protective cover can be mounted (for example from brackets 69 and/or 70) in a position fixed relative 5 to drive unit 66 to protect drive unit 66 from mud, dust and the like.

A release valve (comparable to valves 9 and 42 above) is not shown in FIG. 5, but a suitable arrangement for operating such a valve may be provided in ways similar to those described above.

It will be apparent to persons skilled in the mechanical art that the 10 drive-unit-and-ram arrangements described above may be readily adapted to applications other than the raising and lowering of load trays of trailers and utility and other vehicles. For example, they could be applied to the raising of booms in cranes and the like and generally to applications where a load has to be raised and lowered. The use of hydraulic or pneumatic rams having integral or permanently associated pumps operated by levers, for example those sold as jacks, allows effective load lifting devices to be made in comparatively small sizes, for example where the ram is required to develop a force of in the 500 kg, or 1 tonne or 1.5 tonne ranges, without the expense and complexity of providing, and later maintaining, external hydraulic power supplies.

It is not essential that a rotary motor be used in the drive units as described above. Referring now to FIGS. 6a and 6b, the linkages involved in a lifting mechanism using a motor 80 having a linearly reciprocating plunger 81 is shown. The plunger 81 is connected to one end 82 of a link 83 whose other end 84 is pivotally connected to a pump lever 85 of a ram 86. It can be seen that by the reciprocation of the plunger 81 up and down that the pump lever 85 is also pivoted up and down whereby to operate a pump associated with ram 86.

FIGS. 7 and 8 show a further lifting apparatus 100 of the invention that has been found useful. Apparatus 100 is a particular embodiment of apparatus shown in FIG. 4 and 5, and has a ram 101 foot-mounted on a platform 102 similar to platform 63 (FIG. 5) that is able to pivot about a pivot 103, and piston rod 104 of ram 101 is pivotally connected to a boom 105 at pivot 106, boom 105 being pivotally connected by a pivot 111 to a base 112. Links 107 are pivotally connected to boom 105 and to load supports 108 as shown in the Figures. Apparatus 100 is suitable for mounting to a supporting structure such as a vehicle chassis or frame 109 and load supports 108 are secured to a load 110. (Load 110 is here assumed to be secured movably or guided by additional means not shown, for example pivotally secured to structure 109, and in particular could be a tilting tray as in the earlier-described embodiments. A drive unit 118 is provided that is similar to drive unit 66 of FIG. 5 and actuates pump lever 119. (Drive unit 118 is shown in FIG. 8, but for clarity not in FIG. 7.)

Boom 105 is curved, with its concave side downwards. It has been found that the use of such a curved boom can allow for achieving a compact arrangement with comparatively high load capacity and a short stroke ram. In particular, where limited vertical clearance is available between a vehicle chassis frame and the base of a tilt tray, the arrangement shown in FIGS. 7 and 8 can be advantageous. FIG. 9 shows a cross sectional view of boom 105, which can conveniently be made using channel-section structural section(s). The curved shape of boom 105 can be achieved in manufacture by bending in suitable cases, or by the use of short straight sections welded to produce a similar geometry.

FIGS. 10 and 11 show an arrangement similar to that shown in FIGS. 7 to 9, whereby the boom 122 is shaped in an arc through welding of a plurality of short straight sections. In the embodiment as shown, the arrangement is in the form of a tilting/tipping unit 120 for incorporation into a vehicle, such as a trailer, utility vehicle or the like. Such vehicles typically comprise a tray (not shown) for receiving a load, which can be tipped/tilted to assist in depositing the load from the tray, and/or positioning the load on the tray.

The tipping/tilting unit 120 can be readily installed in the vehicle and has a base 121 which is secured against a chassis or frame of a vehicle, and one or more connector members 123 which are pivotally secured to the tray of the vehicle. In this arrangement, the tipping/tilting unit 120 is secured between the chassis of the vehicle and the tray of the vehicle.

The boom 122 is pivotally mounted at one end to the base 121, and is able to pivot about this point through action of the ram 124. As described above with regard to the alternative embodiments of the present invention, the ram 124 linearly drives a piston rod 127, which is pivotally connected to the boom 122 at a pivot point 128. Extension of the piston rod 127 from the ram 124 causes the boom 122 to extend as shown in FIG. 10. As the boom 122 extends, the ram 124 also pivots to ensure that the piston rod moves in a freely moves in a linear manner. To facilitate this pivot action of the ram 124, the ram 124 is mounted on a platform 125 that is able to pivot about a pivot point 126.

The other end of the boom 122 is attached to the connector members 123 by way of a link 129. The links 129 are pivotally connected to the end of the boom 122 and the connector members 123 to enable the tray to pivot between a tilted position as depicted in FIG. 10, and a flat or level position, as depicted in FIG. 11.

In the position as shown in FIG. 11, the tipping/tilting unit 120 is compactly arranged such that it fits between the chassis of the vehicle and the tray. As shown, the piston rod 127 is retracted into the ram 124 and as such that ram 124 is pivoted into a retracted position as shown.

A drive unit 130 is provided to operate the ram 124 such that the piston rod 127 can move between its extended and retracted positions. The drive unit 130 may be in the form of motor as discussed previously, which operates a pump lever 131 of the ram 124.

It will be appreciated that the tipping/tilting unit 120 can be easily supplied for installation in a vehicle. However, in many instances, it may be necessary to provide associated support frames about the tipping/tilting unit 120 such that the arrangement can be easily incorporated into the structure of the vehicle, without requiring onerous installation techniques to ensure that the tipping/tilting unit 120 is orientated correctly to tilt the tray of the vehicle.

For this reason, the arrangement 140 of FIGS. 12 and 13 has been proposed. As shown, in the arrangement 140, the tipping/tilting unit 120 is mounted between a base frame 135 and a support frame 138. The base frame 135 can be constructed such that it can be easily mounted to the chassis of the vehicle through existing mounting means, such as bolts and the like. Similarly, the support frame 138 can have appropriate mounting means to receive a tray, upon which a load can be supported. Both the base frame 135 and the support frame 138 are pivotally connected at a pivot point 133 such that when the tipping/tilting unit 120 is operated, the support frame 138 is moved with respect to the base frame 135, which in turn causes the tray to tilt/tip with respect to the chassis of the vehicle.

It will be appreciated that such an arrangement 140 enables the present invention to be simply installed in a vehicle between the chassis and the tray of the vehicle, without requiring precision positioning and mounting of the individual components of the tipping/tilting unit 120.

In the arrangements shown in FIGS. 2 and 3, 4 and 5, 7 and 8, 10 and 11, and 12 and 13, drive units 33, 66, 118, and 130 are supported in fixed positions relative to the rams 25, 60 and 124 respectively. However, where only limited movement of a ram is required in a mechanism, it may be practical to hold a drive unit in a fixed position while the ram pivots. In this case, simple pivots (for example at the ends of links 40 or 73) may have to be replaced by ball-and-socket pivots.

Still other variations may be made without exceeding the spirit and scope of the invention.

In this specification the terms “vehicle” and “vehicular” are meant to be interpreted as being applicable both to self-propelled vehicles such as light trucks, utility vehicles and the like, and also to trailers intended for towing by other vehicles.

In this specification, the word “comprise” and its derivatives when used in relation to a set of integers, elements, items or steps is to be taken to mean that the integers, elements, items or steps are present but not to be taken to preclude the possibility that other integers, elements, items or steps are or may be present also.

1. A load lifter for use in vehicular applications comprising:
a ram having a telescoping means and a pump lever operable to extend said telescoping means;
drive means operably coupled to the pump lever, and
means for mounting the ram to a structural part of a vehicle,
wherein the drive means is operable to actuate the pump lever so that the telescoping means is extended to lift a load.

2. A load lifter according to claim 1, wherein, the ram is one of a hydraulic ram and a pneumatic ram and wherein the ram comprises a cylinder and the telescoping means comprises a piston movable within the cylinder.

3. A load lifter according to claim 2, wherein the pump lever is rotatable about a pivot point associated with the cylinder and operatively coupled to a pump.

4. A load lifter according to claim 3, wherein a pump is associated with the cylinder and operable by the pump lever to pump a fluid into the cylinder to extend the telescoping means.

5. A load lifter according to claim 1, wherein the drive means comprises an electric motor.

6. A load lifter according to claim 5, wherein the drive means further comprises means for powering the electric motor from an electrical system of the vehicle.

7. A load lifter according to claim 1, wherein the pump lever is movable by a linearly reciprocating component of the drive means connected by one or more linkages to the pump lever.

8. A load lifter according to claim 7, wherein the drive means in use causes rotation of a crank and a link connects the crank to the pump lever to impart a reciprocating movement to the pump lever.

9. A load lifter according to claim 1, wherein the ram is secured either to a support component that is pivotally mountable to the said structural part of the vehicle or to a base part mounted to the said structural part of the vehicle.

10. A load lifter according to claim 9, wherein the drive means is secured to at least one of the said support component and the ram so as to be in a fixed position relative to the ram.

11. A load lifter according to claim 1, wherein the load to be lifted is or includes a movable part of the vehicle, the load lifter being secured to the structural part of the vehicle and operable to raise and lower the movable part.

12. A load lifter according to claim 11, wherein the movable part of the vehicle is a load tray pivotably mounted to the vehicle the load lifter being operable to raise the tray to a tilted position from a lowered position.

13. A tipping unit for a vehicle comprising.
a base mountable to a body of the vehicle;
one or more connector members attachable to a tipping platform of the vehicle;
a boom arm pivotally connected at a first end to the base and pivotally connected at a second end to the one or more connector members;
a hydraulic jack pivotally mounted to said base and having a piston slidable in a cylinder and a pump for raising said piston, the piston being connectable at a distal end to the boom arm; and
a drive unit mounted to said base and operably coupled to a lever of the pump to drive the pump,
wherein raising of the piston causes the boom arm to move between a first position wherein said tipping platform is substantially horizontal for carrying a load and a second position wherein said tipping platform is angled to the horizontal.

14. A tipping unit according to claim 13, wherein the drive unit is an electric motor.

15. A tipping unit according to claim 14, wherein the motor is adapted to rotate a crank arm that is connected by a link to the pump lever, such that rotation of the crank arm reciprocates the pump lever to raise the piston.

16. A tipping unit according to claim 13, wherein the boom arm is pivotally connected at a second end to the one or more connector members by a link member.

17. A tipping unit according to claim 13, wherein the hydraulic jack further comprises a control unit that controls raising and lowering of the piston.

18. A tipping unit according to claim 17, wherein the control unit is operable to permit bleeding of fluid from the cylinder so that a load acting on the piston lowers the piston, thereby enabling the boom arm to move from said second position to the first position.

19. A tipping unit according to claim 13, wherein the vehicle is one of a trailer, utility vehicle or truck and the tipping platform is a tray of the trailer, utility vehicle or truck.

20. A tipping assembly for a vehicle comprising:
a base frame mountable to a body of the vehicle;
a support frame hingedly attached to the base frame at one end and configured to receive a tipping platform of a vehicle; and
a tipping unit mounted to said base frame and said support frame, said tipping unit having;
a boom arm pivotally connected at a first end to the base frame and pivotally connected at a second end to the support frame;
a hydraulic jack pivotally mounted to said base frame and having a piston slidable in a cylinder and a pump for raising said piston, the piston being connectable at a distal end to the boom arm; and
a drive unit mounted to said base frame and operably coupled to a lever of the pump to drive the pump,
wherein raising of the piston causes the boom arm to move between a first position wherein said support frame is substantially horizontal and a second position wherein said support frame is angled to the horizontal.

21. A tipping assembly according to claim 20, wherein the drive unit is an electric motor.

22. A tipping assembly according to claim 21, wherein the motor is adapted to rotate a crank arm that is connected by a link to the pump lever, such that rotation of the crank arm reciprocates the pump lever to raise the piston.

23. A tipping assembly according to claim 20, wherein the boom arm is pivotally connected at a second end to support frame by a link member.

24. A tipping assembly according to claim 20, wherein the hydraulic jack further comprises a control unit that controls raising and lowering of the piston.

25. A tipping assembly according to claim 24, wherein the control unit is operable to permit bleeding of fluid from the cylinder so that a load acting on the piston lowers the piston, thereby enabling the boom arm to move from said second position to the first position.

26. A tipping assembly according to claim 20, wherein the vehicle is one of a trailer, utility vehicle or truck and the tipping platform is a tray of the trailer, utility vehicle or truck.

27. A tipping assembly according to claim 26, wherein the base frame is directly mounted to the chassis of the vehicle.

28. A tipping assembly according to claim 27, wherein the tipping platform is directly mounted to the support frame.
